(19) United States
(12) Patent Application Publication
(10) Pub. No.: US 2015/0280779 A1
(43) Pub. Date: Oct. 1, 2015

(54) METHOD AND APPARATUS TO IMPROVE THE LINEARITY OF THE TIME DOMAIN TRACE DERIVED FROM A SINGLE ENDED LINE TEST

(71) Applicant: IKANOS COMMUNICATIONS, INC., Fremont, CA (US)

(72) Inventors: Robin LEVONAS, Holmdel, NJ (US); Vipin PATHAK, Eatontown, NJ (US)

(21) Appl. No.: 14/671,391

(22) Filed: Mar. 27, 2015

Related U.S. Application Data
(60) Provisional application No. 61/971,389, filed on Mar. 27, 2014.

(51) Int. Cl. H04B 3/46; H04B 15/00; H04B 17/10

(52) U.S. Cl. CPC H04B 3/46; H04B 17/10; H04B 15/00

(57) ABSTRACT

The present invention is related to improvements to SELT testing, and more particularly to methods and apparatuses for reducing the effects of distortions of the reflected signal without sacrificing the integrity of the original signal. In embodiments, a method according to the invention consists of first modifying the transmit sequence to utilize and better “excite” the low frequency tones. In embodiments, the method includes compensating for transformer roll-off at low frequencies. In other embodiments, the method includes filling gaps in the received frequency domain S11 sequence with a predicted, or estimated, version of the S11 signal.

### CROSS-REFERENCE TO RELATED APPLICATIONS

The present application claims priority to U.S. Prov. Appln. No. 61/971,389, filed Mar. 27, 2014, the contents of which are incorporated herein by reference in their entirety.

### FIELD OF THE INVENTION

The present invention is related generally to SELT testing, and more particularly to methods and apparatuses for reducing the effects of distortions of the reflected signal without sacrificing the integrity of the original signal.

### BACKGROUND OF THE INVENTION

Single Ended Line Testing (SELT) is a technique whereby, as one example, the loop wiring conditions of an xDSL (i.e. ADSL, VDSL2, etc.) connection can be determined and utilized to identify various faults and other impairments that can negatively affect the performance of this service. These faults can consist of, for example, bridge taps, bad splices and line cuts, to name just a few. The SELT technique involves the transmission of a known sequence while simultaneously receiving a reflected version of the same and processing this reflection in a manner that allows the wiring faults to be identified, and possibly classified.

Current SELT techniques do not address the problems that can occur when the reflected signal becomes distorted—not by any faults or impairments in the line, but by inherent or systemic limitations. There exists a need in the art, therefore, to mitigate the effects of distortion of the desired signal as much as possible. For example, it would be desirable to have a method by which the effects of this distortion can be greatly reduced without sacrificing the integrity of the original signal.

### SUMMARY OF THE INVENTION

The present invention is related to improvements to SELT testing, and more particularly to methods and apparatuses for reducing the effects of distortions of the reflected signal without sacrificing the integrity of the original signal. In embodiments, a method according to the invention consists of first modifying the transmit sequence to utilize and better “excite” the low frequency tones. In these and other embodiments, the method includes compensating for transformer roll-off at low frequencies. In other embodiments, the method includes filling gaps in the received frequency domain S11 sequence with a predicted, or estimated, version of the S11 signal.

In accordance with these and other aspects, a method of performing a single ended line test (SELT) in a xDSL modem according to embodiments of the invention includes constructing a sequence of transmit symbols using available tones in a bandplan for the xDSL modem; modifying the sequence of constructed transmit symbols to utilize and better excite low frequency tones in the constructed transmit symbols; and transmitting the sequence of modified constructed transmit symbols through a hybrid of the xDSL modem while simultaneously sensing received symbols corresponding to the modified constructed transmit symbols through the hybrid.

In further accordance with the above and other aspects, an apparatus for performing a single ended line test (SELT) for a xDSL modem includes a mapper that constructs a sequence of transmit symbols using available tones in a bandplan for the xDSL modem; a SELT block that modifies the sequence of constructed transmit symbols to utilize and better excite low frequency tones in the constructed transmit symbols; a transmit path for transmitting the sequence of modified constructed transmit symbols through a hybrid of the xDSL modem; and a receive path for simultaneously sensing received symbols corresponding to the modified constructed transmit symbols through the hybrid.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram of an example SELT apparatus according to embodiments of the invention;

FIG. 2 is a flowchart illustrating an example methodology according to embodiments of the invention;

FIG. 3 is a graph illustrating an example transformer response and compensation gain according to aspects of the invention;

FIG. 4 is a graph illustrating an example time domain signal that has been generated according to embodiments of the invention; and

FIG. 5 is an example S11 that is modified before conversion to time domain according to alternative embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Embodiments of the invention include methods and apparatuses for reducing the effects of distortions in a reflected SELT signal without sacrificing the integrity of the original signal.

According to certain aspects, the present inventors recognize that the post-processing of the reflected signal, in part, involves transforming the measured frequency domain signal to a time domain signal using well known techniques, such as the inverse Fast Fourier Transform (iFFT), as one example. The “optimal” transmit signal would consist of a spectrally flat frequency domain signal that fully spans a range of, for example, from 0 Hz to 17 MHz. In an xDSL transceiver, this would involve transmitting a multi-carrier signal with a tone spacing of 4.3125 KHz yielding a total of 4096 tones spanning the 17 MHz band, with each tone having the same amplitude.

As mentioned above, post processing involves, in part, transforming of the frequency domain reflection coefficient, known as S11, to the time domain such that reflected peaks can be identified and classified to determine wiring faults, etc. However, the present inventors recognize that, due to hardware limitations, it is not always possible for the transmitted signal to span this entire range, especially in the area around 0 Hz (i.e. D.C.). Moreover, typical xDSL transceivers use transformer coupling which, by their very nature, do not pass D.C. In addition to this, there is a high pass effect where the frequency response will roll-off until some usable frequency is reached, usually around 10 kHz or so depending on the transformer response. From the perspective of the SELT receive signal, there is no information in the first several tones. As such, these tones are effectively “zeroed out,” meaning they are effectively equal to 0 in the frequency domain representation of the reflection. This is equivalent to truncation in the frequency domain.

Basic transform theory states that truncation in the frequency domain is, in effect, a form of rectangular windowing. Application of a rectangular window in the frequency domain is equivalent to convolution with a sinc pulse (i.e. sin(x)/x) in the time domain. The present inventors recognize that an effect of this is that the “useful” reflected information is now superimposed on the sinc response, making the identification and classification of wiring faults much more difficult. In other words, when transforming this data to the time domain, the effects of this windowing become visible in the form of ripple, which is a direct result from the convolution of the desired signal with the sinc pulse. This composite signal is now a distorted version of the desired signal and will impede the ability to reliably identify reflection peaks.

For the purpose of this disclosure, this is referred to as time domain trace linearity. In this context, the time domain response resulting from the convolution with a sinc pulse is classified as “not linear or non-linear,” whereas a response that does not contain the convolution with a sinc pulse would be classified as “linear”.

Embodiments of the invention, therefore, aim at reducing the effects of this non-linearity and other distortions in a SELT signal.

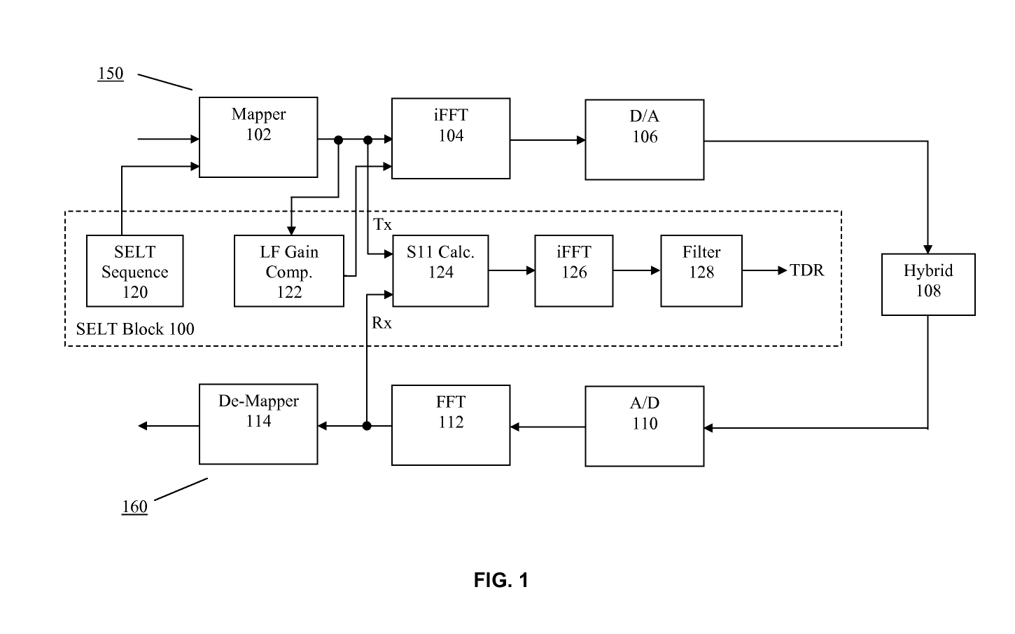

FIG. 1 is a block diagram illustrating an example SELT block 100 according to embodiments of the invention. As shown, block 100 is interposed between a transmit chain 150 and receive chain 160 of a xDSL modem. Embodiments of the invention can be implemented by xDSL modem chipsets and associated firmware such as a Vx185 platform provided by Ikanos Communications. Those skilled in the art will understand how to implement the present invention by adapting these and other chipsets with the SELT functionality of the invention after being taught by the present examples.

It should be noted, that typical xDSL modems include many additional components than shown in FIG. 1, including controllers and other processors that can interact with the components shown in FIG. 1 such as for initiating and performing SELT tests, collecting and storing or transmitting results, etc. Such components and functionalities are well known to those skilled in the art and so additional details thereof will be omitted here for sake of clarity of the invention.

It should be further noted that apparatuses according to the invention are not limited to being incorporated in a xDSL modem as shown in FIG. 1. For example, embodiments of the invention can be incorporated in dedicated testing equipment, remote testing equipment, server side modems, etc.

As shown, block 100 according to embodiments of the invention includes a SELT sequence block 120 that causes mapper 102 to form symbols for performing SELT tests as will be described in more detail below. The symbols formed by mapper 102 are processed further by low frequency gain compensation block 122 to compensate for low frequency rolloff as will be described in more detail below. The adjusted symbols are converted to time domain by iFFT 104, converted to analog signals by A/D 106 and transmitted onto the tip/ring connection of the modem via hybrid 108. Meanwhile, the non-adjusted symbols (Tx) are provided to S11 calculation block 124. The reflections of the transmitted signals are simultaneously sensed via hybrid 108, digitized by A/D 110 and converted to frequency domain by FFT 112. Instead of being converted to data by de-mapper 114, the reflected symbols (Rx) are provided to S11 calculator block 124. Using the transmitted symbols (Tx) and the reflected symbols (Rx), block 124 determines the S11 signal using known techniques (e.g. S11=Rx/Tx). The frequency domain S11 signal from block 124 is converted to time domain by iFFT 126 and filtered by filter 128 as will be described in more detail below to form the time domain reflectrometry (TDR) signal that can be analyzed in the conventional manner.

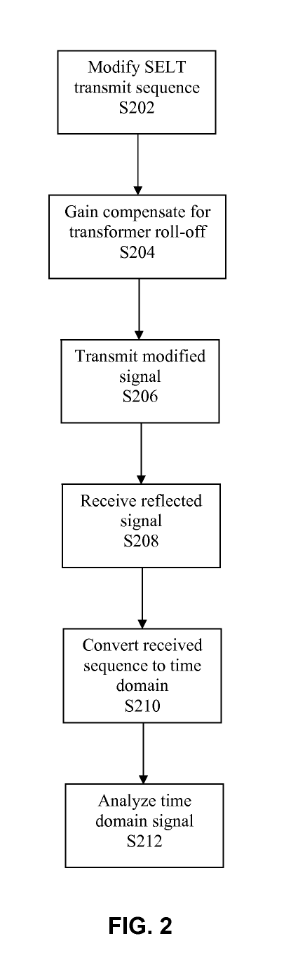

An example methodology according to embodiments of the invention is shown in FIG. 2. This methodology will be described in connection with an operation of SELT block 100 described above, as well as by associated controllers and processors as will be appreciated by those skilled in the xDSL modem arts. However, the methodology of the invention is not limited to being performed by the example block shown in FIG. 1, but can be included in dedicated testing equipment, remote testing equipment, etc.

According to certain aspects, embodiments of the invention modify the symbols used during SELT tests before they are transmitted. As shown, a first step S202 consists of modifying the transmit symbol sequence to utilize the low frequency tones. For example, during SELT tests using a modem operating in accordance with VDSL2, block 120 can cause mapper 104 to create a 4 kHz periodic transmit sequence of REVERB symbols, in which all available tones (e.g. tones 6 to 4096 in the bandplan of a conventional VDSL2 system) are modulated using the exact same QAM constellation point (e.g. [1,0] or [1,1]). Preferably, tones from both upstream and downstream bands are used (see, e.g. U.S. patent application Ser. No. 14/339,862 filed Jul. 24, 2014, the contents of which are incorporated herein by reference in their entirety), but this is not necessary in all embodiments. In embodiments, the sequence is performed for about 5 seconds to about 240 seconds.

Notably different from conventional SELT tests, however, according to aspects of the invention, in step S202 block 120 further causes mapper 104 to create symbols that also modulate the lowest frequency tones 1 to 5 using the same constellation point mapped to the other tones 6 to 4096. As such, the modified symbols will be closer to an “optimal” transmit signal, thereby substantially overcoming the windowing effect described above.

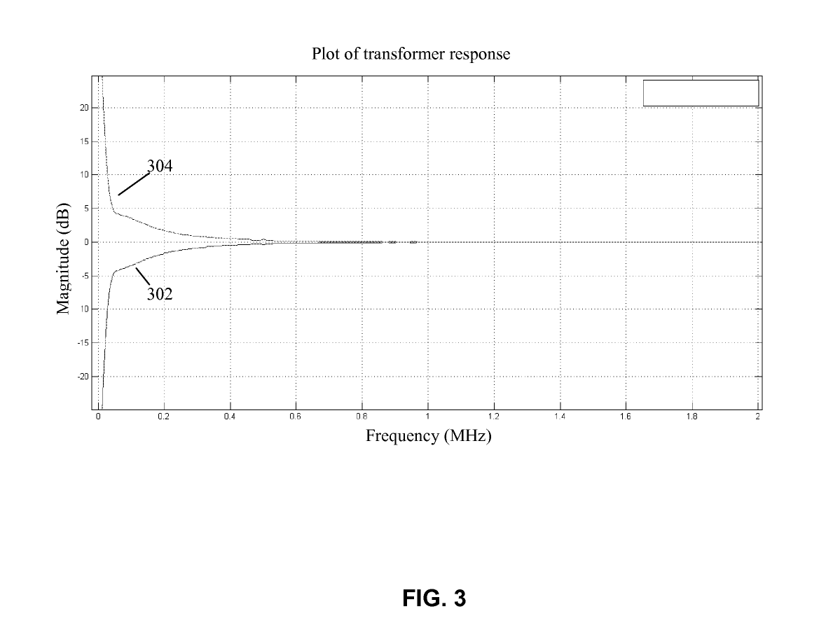

According to certain other aspects, the effects of the transformer roll-off can be partially compensated for in step S204. In embodiments of the invention, this is done in compensation block 122 by increasing the transmit power of the low frequency tones in an inverse manner to the transformer roll-off, such that the net effect is a spectrally flat signal as seen at the transceiver Tip/Ring terminals. For example, FIG. 3 is a graph that illustrates an example of these aspects. Plot 302 in FIG. 3 is an example of a transformer response, which shows a sharp roll-off near D.C. Knowing this response, block 122 can apply a frequency-dependent gain such as that shown in plot 304 to the mapped symbols from mapper 102 before they are provided to the iFFT 104.

There are many ways the gain applied by block 122 can be determined. For example, the transformer to be used in all modems of a particular modem design can be analyzed in advance and the gain can be pre-programmed into the modem. As another example, the transformer roll-off can be dynamically measured at or before the time of SELT tests.

A next step S206 includes transmitting the modified signal. This can be done in the conventional manner as described above in connection with the xDSL modem shown in FIG. 1.

A next step S208 includes simultaneously receiving the reflected signal Rx, which can be done in the conventional manner as described above in connection with the xDSL modem shown in FIG. 1.

Next in step S210, the frequency domain S11 signal is calculated by block 124 (e.g. by determining the ratio between Tx and Rx) and the frequency domain S11 signal is converted to time domain using an iFFT, for example. It should be noted that, when the SELT tests are performed using symbols transmitted at a 4 kHz rate over a span of 5 to 240 seconds as described above, average values of the received symbols over the transmit span can be formed and used for forming the S11 signal and final TDR signal to be analyzed.

In a next step S212, the time domain signal is filtered in block 128, for example, by a Finite Impulse Response (FIR) low pass filter. The low frequency cutoff is preferably chosen so as to remove high frequency noise without sacrificing the integrity of the resultant time domain signal. The final TDR signal after filtering is output and can be analyzed using SELT techniques known to those skilled in the art. See, for example, U.S. patent application Ser. Nos. 14/341,538 and 14/341,576, commonly owned by the present assignee, the contents of which are incorporated by reference herein in their entirety.

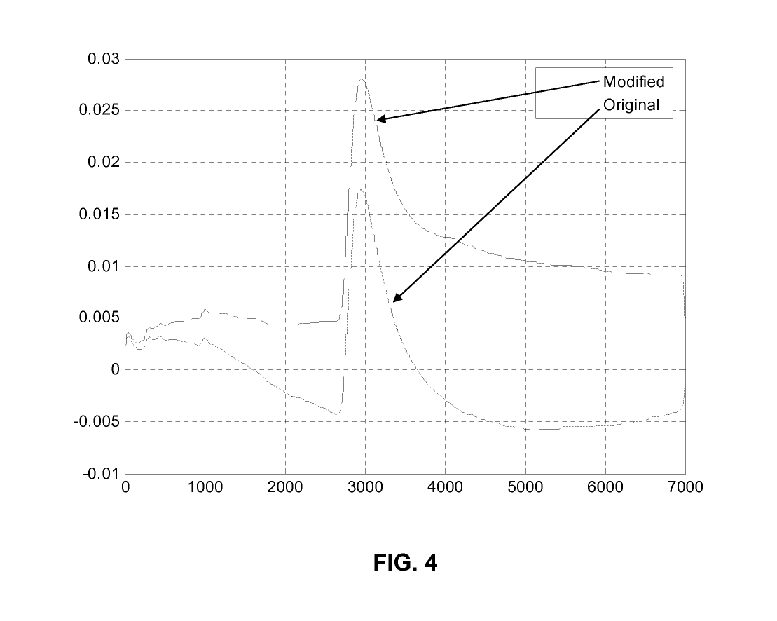

FIG. 4 is a plot illustrating an example TDR signal in accordance with aspects of the invention. FIG. 4 compares a TDR signal that has been obtained wherein the transmit signal has been modified in the manner described above in connection with step S202 and S204. FIG. 4 further illustrates a TDR signal obtained using an original unprocessed transmit signal. As shown, the TDR signal using the original transmit signal exhibits a characteristic “dip” below the x-axis. This is the result of windowing the frequency domain data and transforming this to the time domain through use of the iFFT operator, as described above. By extending the transmit signal to span the tones below tone 5, the characteristic dip is largely removed as seen in the modified TDR trace of FIG. 4.

As further shown in FIG. 4, in comparison with the original received time domain signal, the modified received time domain signal exhibits a much flatter response up to the first positive peak. Analysis of the time domain response could erroneously flag the dip below the x axis in the original trace as a negative going peak, which of course does not represent the true line topology. The modified received time domain signal does not exhibit this dip and consequently will not be misinterpreted.

Another advantage of this technique is that the integrity of the desired signal is maintained. In addition, there is only minimal additional processing required.

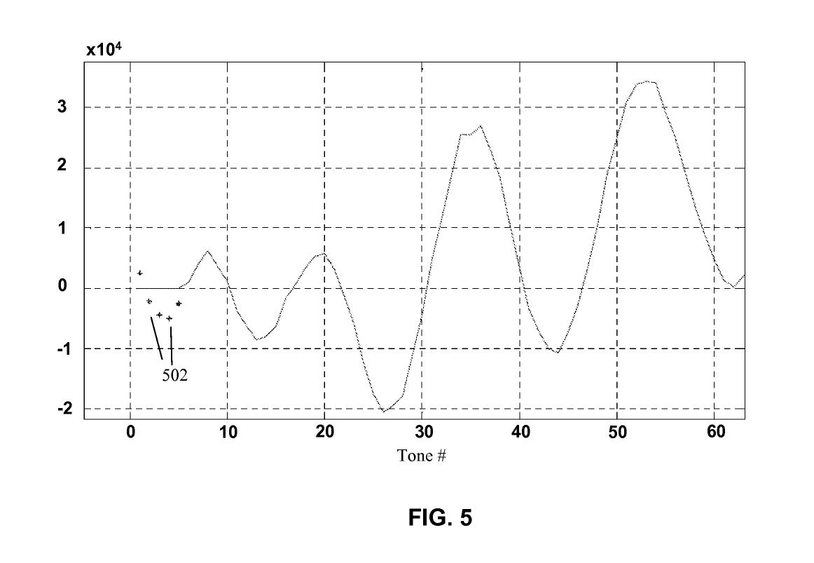

FIG. 5 is a graph illustrating aspects of alternative embodiments of the invention. This alternative embodiment can be used in cases where it is not possible or not desired to use low frequency tones in the transmit signal as is done in step S202 in the example methodology of the present invention described above. As shown in the example of FIG. 5, the missing frequency domain information 502 in the S11 signal for the lower tones 1 to 5 is reconstructed, or estimated, through use of linear prediction. This can be implemented by block 124 using linear prediction techniques well-known to those skilled in the art. Since the S11 signal has a highly correlated response, it is possible to use a linear predictor to estimate the remaining samples, thereby filling the gap to D.C. The net effect of this operation is that the resultant time domain signal (i.e. after processing by iFFT block 126) can be cleaned up without any visible artifacts of the frequency domain truncation.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method of performing a single ended line test (SELT) in a xDSL modem comprising:
constructing a sequence of transmit symbols using available tones in a bandplan for the xDSL modem;
modifying the sequence of constructed transmit symbols to utilize and better excite low frequency tones in the constructed transmit symbols; and
transmitting the sequence of modified constructed transmit symbols through a hybrid of the xDSL modem while simultaneously sensing received symbols corresponding to the modified constructed transmit symbols through the hybrid.

2. A method according to claim 1, wherein constructing includes mapping a common QAM constellation point to the available tones, and wherein modifying includes mapping the common QAM constellation point to additional low frequency tones that are not included in the bandplan for the xDSL modem.

3. A method according to claim 2, wherein the bandplan is associated with a VDSL2 system and wherein the additional low frequency tones are tones 1 to 5.

4. A method according to claim 1, wherein modifying includes applying a compensation gain to the low frequency tones.

5. A method according to claim 4, wherein the compensation gain corresponds to a roll-off of a transformer in the xDSL modem.

6. A method according to claim 5, wherein the roll-off has been predetermined and stored in the xDSL modem.

7. A method according to claim 1, wherein constructing includes using both upstream and downstream tones in the bandplan.

8. A method according to claim 7, wherein constructing includes mapping a common QAM constellation point to the upstream and downstream tones, and wherein modifying includes mapping the common QAM constellation point to additional low frequency tones that are not included in the bandplan for the xDSL modem.

9. A method according to claim 1, wherein the constructed transmit symbols are REVERB symbols.

10. An apparatus for performing a single ended line test (SELT) for a xDSL modem comprising:
a mapper that constructs a sequence of transmit symbols using available tones in a bandplan for the xDSL modem;
a SELT block that modifies the sequence of constructed transmit symbols to utilize and better excite low frequency tones in the constructed transmit symbols;
a transmit path for transmitting the sequence of modified constructed transmit symbols through a hybrid of the xDSL modem; and
a receive path for simultaneously sensing received symbols corresponding to the modified constructed transmit symbols through the hybrid.

11. An apparatus according to claim 10, wherein the mapper constructs the sequence of constructed transmit symbols by mapping a common QAM constellation point to the available tones, and wherein the SELT block causes the mapper to further map the common QAM constellation point to additional low frequency tones that are not included in the bandplan for the xDSL modem.

12. An apparatus according to claim 11, wherein the bandplan is associated with a VDSL2 system and wherein the additional low frequency tones are tones 1 to 5.

13. An apparatus according to claim 10, wherein the SELT block includes a low frequency gain compensation block that applies a compensation gain to the low frequency tones.

14. An apparatus according to claim 13, wherein the compensation gain corresponds to a roll-off of a transformer in the xDSL modem.

15. An apparatus according to claim 14, wherein the roll-off has been predetermined and stored in the xDSL modem.

16. An apparatus according to claim 10, wherein the mapper uses both upstream and downstream tones in the bandplan.

17. An apparatus according to claim 16, wherein the mapper constructs the sequence of constructed transmit symbols by mapping a common QAM constellation point to the upstream and downstream tones, and wherein the SELT block causes the mapper to further map the common QAM constellation point to additional low frequency tones that are not included in the bandplan for the xDSL modem.

18. An apparatus according to claim 10, wherein the constructed transmit symbols are REVERB symbols.
